(19) United States
(12) Patent Application Publication
(10) Pub. No.: US 2008/0126002 A1
(43) Pub. Date: May 29, 2008

(54) SYSTEM AND METHOD FOR AUTOMATICALLY ADJUSTING LENGTH OF TEST LINE, AND TEST SYSTEM

(75) Inventors: KUNG-TAI CHANG, Tu-Cheng (TW); WEN-JING TAO, Shenzhen (CN); ZI-QIONG LI, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/620,050

(22) Filed: Jan. 5, 2007

(30) Foreign Application Priority Data
Sep. 8, 2006 (CN) 200610062515.X

(51) Int. Cl. G06F 19/00

(52) U.S. Cl. 702/120

(57) ABSTRACT

A test system for testing a network device is provided. The test system includes a control device and a cable group. The control device receives a user instruction, generates a test instruction according to the user instruction, and includes a control board and a relay board. The control board parses the test instruction, and generates a control signal. The relay board is connected to the control board, and comprises a plurality of switches, various of the switches are switched on or off according to the control signal. The cable group includes a plurality of cables with different lengths, the cables electrically connected to the switches, for forming a test line with a required length according to the control signal. A system and a method for automatically adjusting a length of a test line are also provided.

### BACKGROUND OF THE INVENTION

1. Field of the Invention

The invention generally relates to a system, and particularly to a system for automatically adjusting a length of a test line.

2. Description of Related Art

In a typical environment for testing a network device, it is often required to test transmission performance of the network device with different lengths of cables. A popular solution is to manually plug these cables to a plurality of patch panels as required, to form a test line with different lengths. However, a big problem with the above solution is that there are a large number of network devices to be tested, and errors easily happen during the manual operations, which decrease test efficiency.

Therefore, a heretofore unaddressed need exists in the industry to overcome the aforementioned deficiencies and inadequacies.

### SUMMARY OF THE INVENTION

A test system for testing a network device is provided. The test system includes a control device and a cable group. The control device receives a user instruction, generates a test instruction according to the user instruction, and includes a control board and a relay board. The control board parses the test instruction, and generates a control signal. The relay board is connected to the control board, and comprises a plurality of switches, the switches switch on or off according to the control signal. The cable group includes a plurality of cables with different lengths, the cables are electrically connected to the switches, for forming a test line with a required length.

A system for automatically adjusting a length of a test line is also provided. The system includes a cable group, a relay board, and a control board. The cable group includes a plurality of cables with different lengths. The relay board is connected to the cable group, and includes a plurality of switches. The control board is connected to the relay board, and includes a central processing module, the central processing module generates a control signal, to control the switches.

A method for automatically adjusting a length of a test line is further provided. The method includes providing a plurality of cables and switches; receiving a user instruction, and generating a test instruction according to the user instruction; parsing the user instruction to generate a control signal; and controlling the switches according to the control signal, to form the test line with a required length.

Other advantages and novel features will become more apparent from the following detailed description when taken in conjunction with the accompanying drawings, in which:

### BRIEF DESCRIPTION OF THE DRAWINGS

FIG. 1 is a schematic diagram of a test system of an exemplary embodiment of the invention;

FIG. 2 is a block diagram of a relay board 106 in FIG. 1;

FIG. 3 is a schematic diagram of a test path of a test system 10 in FIG. 1;

FIG. 4 is a block diagram of a control board in FIG. 1; and

FIG. 5 is a flowchart of a method for automatically adjusting a length of a test line.

### DETAILED DESCRIPTION OF THE INVENTION

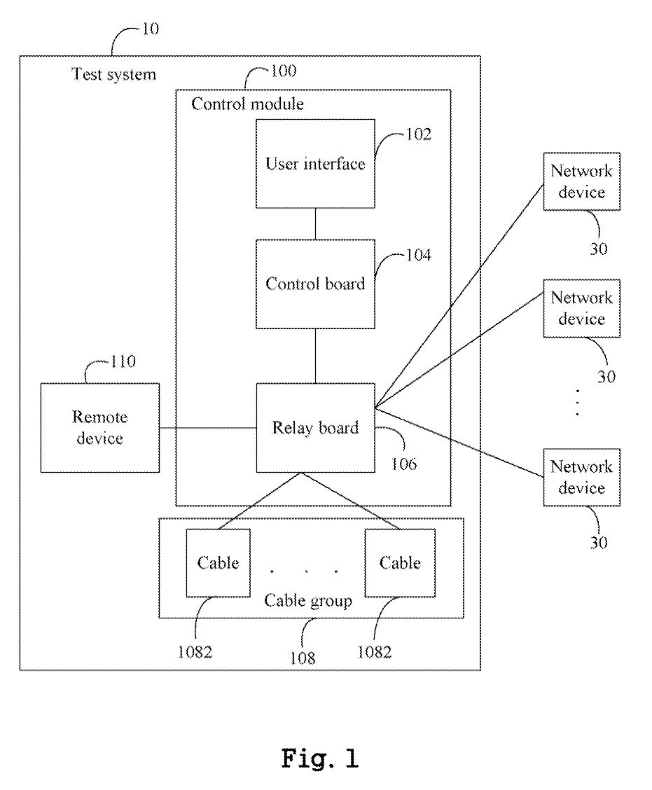

FIG. 1 is a schematic diagram of a test system 10 of an exemplary embodiment of the invention.

The test system 10 is for testing a plurality of network devices 30, and includes a control device 100, a cable group 108, and a remote device 110. In this embodiment, the network device 30 is a modem, the control device 100 is a personal computer (PC), and the remote device 110 is a digital subscriber line access multiplexer (DSLAM).

In this embodiment, the control device 100 includes a user interface 102, a control board 104, and a relay board 106. In other embodiments, the user interface 102, the control board 104, and the relay board 106 may be separately arranged in different PCs, and a user may control the test system 10 via the user interface 102.

The cable group 108 includes a plurality of cables 1082 with different lengths. In this embodiment, the lengths include 100 miles, 200 miles, 300 miles, and 500 miles.

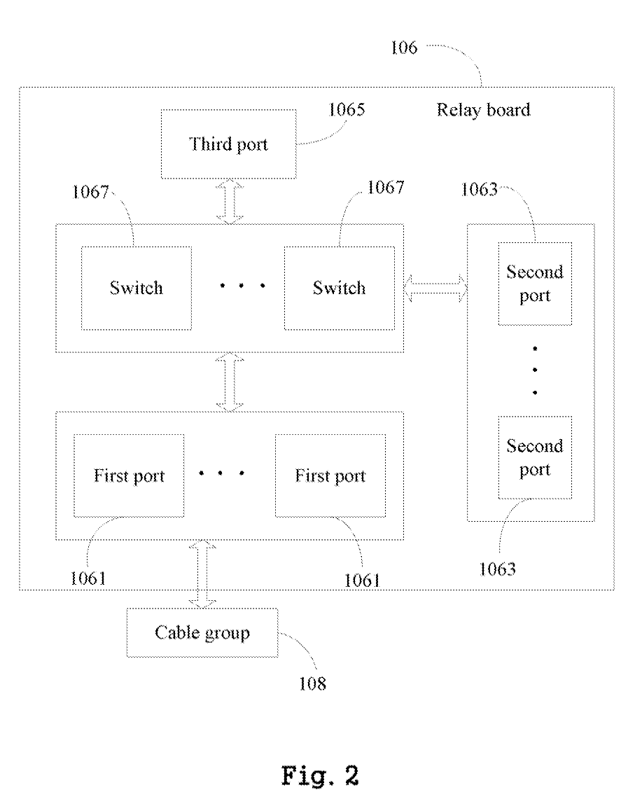

FIG. 2 is a block diagram of the relay board 106 in FIG. 1. The relay board 106 includes a plurality of first ports 1061, a plurality of second ports 1063, a plurality of ports 1065, and a plurality of switches 1067. In this embodiment, the switches 1067 are relays.

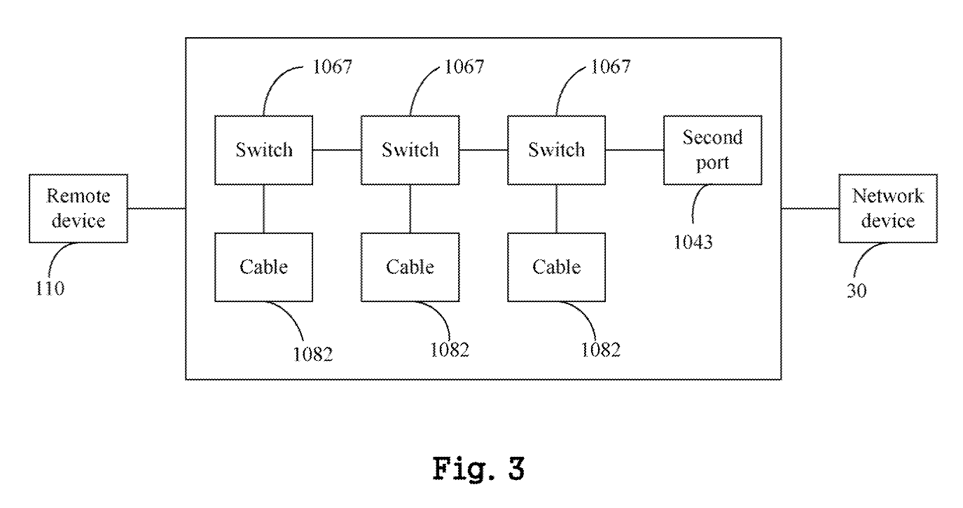

Now referring to FIG. 3, a schematic diagram of a test path of the test system 10 in FIG. 1 is illustrated.

As shown in FIG. 1, a plurality of cables 1082, a plurality of switches 1067, and a second port 1063 form a test path. The switches 1067 are serially connected, and each of the switches 1067 is connected to a cable 1082. Different combinations of switches 1067 being on and/or off provide a test line with different lengths. For example, if all the switches 1067 are switched on, the length of the test line is equal to lengths of the cables 1082 to which all the switches 1067 are connected.

The second port 1063 connects the network device 30 to the test path. In this embodiment, the number of the second ports 1063 is equal to that of the test paths. Moreover, each of the second ports 1063 has a port number, each of the test paths has a path number, and the port number is equal to the path number.

The third port 1065 connects the control board 104 to the relay board 106. In this embodiment, the third port 1065 is an analog input/output port.

The control module 100 receives a user instruction, and generates a test instruction according to the user instruction. In this embodiment, the user instruction includes a port number of the second port 1063 to which the network device 30 is connected, and a required length of the test line.

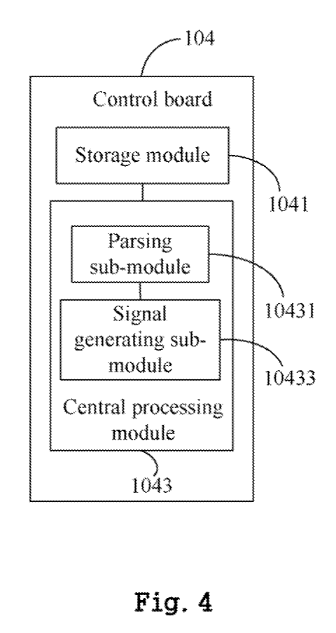

FIG. 4 is a block diagram of the control board in FIG. 1.

In this embodiment, the control device 100 further includes a RS-232 serial interface connected to the control board 104. The control board 104 includes a storage module 1041 and a central processing module 1043.

The storage module 1041 stores an address of the switch 1067, a length of a cable 1082 to which the switch 1067 is connected, and a path number of a test path to which the cable 1082 belongs.

The central processing module 1043 parses the test instruction to generate a control signal, and controls the switches 1067 via the control signal.

The central processing module 1043 includes a parsing sub-module 10431 and a signal generating module 10433.

The parsing sub-module 10431 parses the test instruction, and generates a parsing result. In this embodiment, the parsing result includes addresses of all switches 1067 corresponding to the second port 1063, and lengths of cables 1082 connected to the switches 1067.

The signal generating sub-module 10433 generates a control signal according to the parsing result and the user instruction.

In this embodiment, the signal generating sub-module 10433 firstly determines whether there are different ways to generate the required length included in the test instruction. If there are different ways to generate the required length, the signal generating sub-module 10433 chooses a way having the least number of switches 1067 to generate the control signal, otherwise the signal generating sub-module 10433 directly generates the control signal.

For example, if the required length of the test line is 600 miles, then there are two ways of forming the required length, one of which is to switch on a switch 1067 connected to the 500 mile cable 1082 and a switch 1067 connected to the 100 mile cable 1082, the other is to switch on a switch 1067 connected to the 100 mile cable 1082, a switch 1067 connected to the 200 mile cable 1082, and a switch 1067 connected to the 300 mile cable 1082. At this point, in view of the number of cables 1082, the signal generating sub-module 10433 chooses to switch on the switch 1067 connected to the 500 mile cable 1082 and a switch 1067 connected to the 100 mile cable 1082.

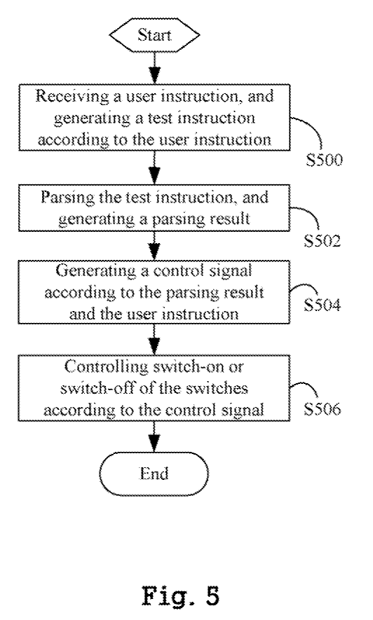

FIG. 5 is a flowchart of a method for automatically adjusting a length of a test line.

In step S500, the user interface 1001 receives a user instruction, and generates a test instruction according to the user instruction. In this embodiment, the user instruction includes a port number of the second port 1063 to which the network device 30 is connected, and a required length of the test line.

In step S502, the parsing sub-module 10431 parses the test instruction, and generates a parsing result. In this embodiment, the parsing result includes addresses of all switches 1067 corresponding to the second port 1063, and lengths of cables 1082 connected to the switches 1067.

In step S504, the signal generating sub-module 10433 generates a control signal according to the parsing result and the user instruction.

In this embodiment, the signal generating sub-module 10433 firstly determines whether there are different ways to generate the required length included in the test instruction. If there are different ways to generate the required length, the signal generating sub-module 10433 chooses a way having the least number of switches 1967 to generate the control signal, otherwise the signal generating sub-module 10433 directly generates the control signal.

In step S506, controlling switch-on or switch-off of the switches according to the control signal, to form the test line with the required length.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A test system for testing a network device, the test system comprising:
a control device for receiving a user instruction, and for generating a test instruction according to the user instruction, the control device comprising:
a control board for parsing the test instruction, and for generating a control signal; and
a relay board connected to the control board and comprising a plurality of switches, various of the switches to be switched on or off according to the control signal; and
a cable group comprising a plurality of cables with different lengths, the cables electrically connected to the switches, for forming a test line with a required length according to a current combination of switches being on or off.

2. The test system in accordance with claim 1, wherein the switches are serially connected.

3. The test system in accordance with claim 2, wherein the switches are relays.

4. The test system in accordance with claim 1, wherein the control board comprises a plurality of ports for connecting the network device to the switches, each of the ports having a port number.

5. The test system in accordance with claim 4, wherein the cables, the switches, and the ports form a plurality of test paths, each of the paths having a path number equal to the port number.

6. The test system in accordance with claim 1, further comprising a user interface, via which the control device receives the user instruction.

7. The test system in accordance with claim 6, wherein the user instruction comprises:
a port number of a port to which the network device is connected, and
a required length of a test line.

8. The test system in accordance with claim 1, wherein the control board comprises:
a storage module for storing addresses of the switches, lengths of the cables to which the switches are connected, and a path number of a test path to which the cables belong; and
a central processing module for parsing the test instruction, to generate the control signal.

9. The test system in accordance with claim 8, wherein the central processing module comprises:
a parsing sub-module for parsing the test instruction, to generate a parsing result, the parsing result comprising addresses of switches corresponding to the ports, and lengths of cables connected to the switches; and
a signal generating sub-module for generating the control signal, to control the switches.

10. A system for automatically adjusting a length of a test line, comprising:
a cable group comprising a plurality of cables with different lengths;
a relay board connected to the cable group and comprising a plurality of switches; and
a control board connected to the relay board and comprising a central processing module, the central processing module generating a control signal, to control the switches of the relay board.

11. The system in accordance with claim 10, wherein the control board further comprises a storage module for storing addresses of the switches, and lengths of cables connected to the switches.

12. The system in accordance with claim 11, wherein the central processing module comprises a signal generating sub-module for generating the control signal, to control various of the switches—to be on or off.

13. A method for automatically adjusting a length of a test line, comprising:
providing a plurality of cables and switches;
receiving a user instruction, and generating a test instruction according to the user instruction;
parsing the user instruction to generate a control signal; and
controlling various combinations of the switches to be on or off according to the control signal, to form the test line with a required length.

14. The method in accordance with claim 13, further comprising providing a storage module for storing addresses of the switches and lengths of cables connected to the switches.

15. The method in accordance with claim 13, wherein the user instruction comprises a required length of the test line.

16. The method in accordance with claim 15, further comprising determining whether there are different ways to construct the required length.

17. The method in accordance with claim 16, further comprising choosing a way having the least number of switches and generating the control signal corresponding the way having the least number of switches if there are different ways to construct the required length.

18. The method in accordance with claim 17, further comprising directly generating the control signal if there are no different ways to construct the required length.
